(19) United States
(12) Patent Application Publication
(10) Pub. No.: US 2026/0312783 A1
(43) Pub. Date: Oct. 8, 2026

(54) SELF-INTERFERENCE CANCELLATION METHOD FOR FULL-DUPLEX COMMUNICATION AND DEVICE SUPPORTING THE SAME

(71) Applicant: ELECTRONICS AND TELECOMMUNICATIONS RESEARCH INSTITUTE, Daejeon (KR)

(72) Inventor: Byung Jang JEONG, Daejeon (KR)

(73) Assignee: ELECTRONICS AND TELECOMMUNICATIONS RESEARCH INSTITUTE, Daejeon (KR)

(21) Appl. No.: 19/636,342

(22) Filed: Apr. 1, 2026

(30) Foreign Application Priority Data
Apr. 7, 2025 (KR) 10-2025-0044576

(51) Int. Cl. H04L 5/14; H04B 1/04; H04B 1/10

(52) U.S. Cl. CPC H04L 5/14; H04B 1/0475; H04B 1/1036

(57) ABSTRACT

Disclosed is a wireless device for cancelling self-interference in a communication system supporting full-duplex communication. The wireless device includes a transmission module configured to modulate transmission data in a baseband, upconvert a modulated signal to a radio frequency, and transmit a transmission signal through signal amplification, a reception module configured to recover a signal by downconverting a reception signal to a baseband and demodulating the reception signal, and a self-interference signal cancellation module configured to estimate a self-interference (SI) signal by estimating a channel for signal transfer from the transmission module to the reception module using a predefined sequence and to remove the estimated self-interference signal from the reception signal.

### CROSS-REFERENCE TO RELATED APPLICATION

The present application claims priority to and the benefit of Korean Patent Application No. 10-2025-0044576, filed on Apr. 7, 2025, in the Korean Intellectual Property Office, the entire disclosure of which is incorporated herein by reference.

### BACKGROUND

### 1. Technical Field

The present disclosure relates to a self-interference cancellation method for full-duplex communication, which may be applied to 5G-Advanced and 6G mobile communications, short-range wireless communications, and communication-radar convergence technologies.

### 2. Related Art

In mobile communications represented by 4G and 5G and in wireless communications such as Wi-Fi, transmission and reception are generally performed simultaneously. A method for simultaneously performing transmission and reception is referred to as duplexing, wherein duplexing may be broadly classified into Time Division Duplex (TDD) and Frequency Division Duplex (FDD).

In TDD, DL and UL are divided within a slot by OFDM symbol. That is, measures are taken to ensure that no reception signal is present during a slot period in which a transmission signal is sent, and conversely, no transmission signal is sent during a slot period in which a reception signal is to be received, thereby preventing interference between the transmission signal and the reception signal. Because transmission and reception are not simultaneously performed in a strict sense in TDD, TDD is also referred to as half duplex.

In FDD, in order to transmit a transmission signal and receive a reception signal at the same time, different frequency bands are used for the transmission signal and the reception signal, thereby minimizing interference between the transmission and reception signals. Because transmission and reception are simultaneously performed in FDD, FDD is referred to as a full duplex scheme, but a downlink (DL) band and an uplink (UL) band need to be separately present, and thus frequency bands should be allocated as a paired spectrum.

Same-band full duplex (FD) is a scheme in which transmission and reception are simultaneously performed using a single spectrum band, and is recently considered by organizations such as 3GPP for next-generation mobile communications. Same-band full-duplex is classified into In-Band Full Duplex (IBFD) or similarly defined Spectrum Shared Full Duplex (SSFD) where transmission and reception occur simultaneously across the entire band, and SubBand Full Duplex (SBFD) where the entire band is divided into subbands for DL and UL to simultaneously perform transmission and reception. Because, in both IBFD and SBFD schemes, a transmission signal is directly/indirectly coupled to a receiver and the strength of a received signal (or reception signal) is high, a technique for removing interference of a transmission signal with a reception signal is one of key technologies. A transmission signal, which is received by the receiver, is referred to as self-interference.

A self-interference signal may act as interference in the receiver through various paths such as a portion leaking into a receive antenna through a transmit antenna and a portion leaking from the transmission circuit into a reception circuit, thus degrading reception performance.

### SUMMARY

Embodiments of the present disclosure are directed to providing a Digital Self-Interference Cancellation (D-SIC) technology in a digital domain for In-Band Full Duplex (IBFD) and SubBand-Full Duplex (SBFD).

Embodiments of the present disclosure are directed to providing a method for estimating and regenerating a self-interference signal and removing the self-interference signal from an overall reception signal, thus attenuating the influence of the interference signal.

Embodiments of the present disclosure are directed to providing an adaptive D-SIC scheme for compensating for a time-varying portion of a self-interference channel because the characteristics of a transmission signal may vary with time due to various factors during a process in which the transmission signal reaches a receiver.

The objects of the present disclosure are not limited to the above-mentioned objects, and those skilled in this art to which the present disclosure pertains will be able to clearly understand other unmentioned objects from the following description.

A wireless device for cancelling self-interference in a communication system supporting full-duplex communication according to embodiments of the present disclosure may include a transmission unit configured to modulate transmission data in a baseband, upconvert a modulated signal to a radio frequency, and transmit a transmission signal through signal amplification, a reception unit configured to recover a signal by downconverting a reception signal to a baseband and demodulating the reception signal, and a self-interference signal cancellation module configured to estimate a self-interference (SI) signal by estimating a channel for signal transfer from the transmission unit to the reception unit using a predefined sequence and to remove the estimated self-interference signal from the reception signal.

Further, in the present specification, the self-interference signal cancellation module may include a Digital Self-Interference Cancellation (D-SIC) weight estimation unit configured to estimate the channel using the predefined sequence, and a self-interference reconstruction unit configured to estimate the self-interference signal through the channel estimated by the D-SIC weight estimation unit.

Furthermore, in the present specification, the predefined sequence may be composed of an output signal of a power amplifier of the transmission unit and a preset gain.

Furthermore, in the present specification, the predefined sequence may be fed back from the transmission unit to the reception unit through an auxiliary path of the wireless device.

Furthermore, in the present specification, the channel for signal transfer from the transmission unit to the reception unit may be a time-invariant channel or a time-varying channel.

A method for a mobile device to cancel self-interference in a communication system supporting full-duplex communication according to embodiments of the present disclosure may include estimating a channel for signal transfer from a transmission unit of the wireless device to a reception unit of the wireless device using a predefined sequence, estimating a self-interference (SI) signal based on channel estimation, and removing the estimated self-interference signal from a reception signal that is received by the reception unit.

Further, in the present specification, the method may further include transmitting a transmission signal, and recovering a reception signal from which the estimated self-interference signal is removed.

The present specification may estimate a weight vector of D-SIC operating in a digital domain based on a D-SIC scheme and structure by utilizing a certain sequence that is previously known.

Further, the present specification is advantageous in that it employs a scheme capable of obtaining an optimal weight vector for an arbitrary signal rather than based on a specific reference signal, thus enabling application of the scheme at any time if channel re-estimation is required.

Furthermore, the present specification may continuously track and estimate channel changes by applying an adaptive algorithm of an LMS algorithm type so as to cope with cases in which a channel gradually changes.

In addition, the present specification verifies the validity of the method proposed herein through simulation results, and exhibits that a D-SIC scheme proposed in the present specification is capable of canceling the power level of a self-interference signal down to a noise floor level.

The effects of the present disclosure are not limited to the above-mentioned effects, and those skilled in this art to which the present disclosure pertains will be able to clearly understand other unmentioned effects from the following description.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings:

FIGS. 1A and 1B illustrate examples of allocation of uplink and downlink resources for same-band full duplex communication to which a method proposed in the present specification is applicable.

FIG. 2 illustrates an example of a conceptual internal block diagram of an overall physical layer system for same-band full duplex communication proposed in the present specification.

FIG. 3 illustrates an example of an internal block diagram for applying D-SIC proposed in the present specification.

FIG. 4 is a flowchart illustrating an example of a D-SIC method proposed in the present specification.

FIGS. 5A and 5B illustrate an example of the results of simulations conducted to verify the practical effectiveness of a method proposed in the present specification.

FIG. 6 is a flowchart illustrating an example of a method for a wireless device to cancel self-interference in a communication system supporting full-duplex communication proposed in the present specification.

### DETAILED DESCRIPTION

It should be noted that the technical terms used in the present disclosure are merely used for the purpose of describing specific embodiments, and are not intended to limit the spirit of technology disclosed in the present specification. Further, unless otherwise expressly defined herein, technical terms used in the present specification should be construed according to meanings generally understood by those of ordinary skill in the art to which the disclosed technology pertains, and should not be construed in an overly broad or overly narrow sense. Further, when any technical term used herein is an incorrect technical term that does not accurately express the spirit of the technology disclosed in the present specification, such term should be replaced with a technical term that can be correctly understood by those skilled in the art to which the disclosed technology pertains. Furthermore, general terms used in the present specification should be interpreted as defined in dictionaries or according to the surrounding context, and should not be interpreted in an excessively narrow sense.

Although terms including ordinal numbers such as “first” and “second” used in the present disclosure may be used herein to describe various components, the components should not be limited by these terms. These terms are used merely to distinguish one component from other components. For example, a first component may be referred to as a second component without departing from the scope of the present disclosure. Similarly, a second component may be referred to as a first component without departing from the scope of the present disclosure.

Hereinafter, embodiments disclosed in the present specification will be described in detail with reference to the accompanying drawings. Throughout the drawings, identical or similar components will be denoted by the same reference numerals regardless of the drawing reference symbols, and redundant descriptions thereof will be omitted.

In addition, in describing the technology disclosed in the present disclosure, if it is determined that a detailed description of a related known technology may obscure the gist of the technology disclosed herein, the detailed description thereof will be omitted. Furthermore, it should be noted that the accompanying drawings are provided merely to facilitate an understanding of the spirit of the technology disclosed in the present specification, and should not be construed as limiting the spirit of the technology by the accompanying drawings.

Hereinafter, a Digital Self-Interference Cancellation (D-SIC) method proposed in the present specification and a configuration and a structure for the D-SIC method will be described in detail with reference to related drawings.

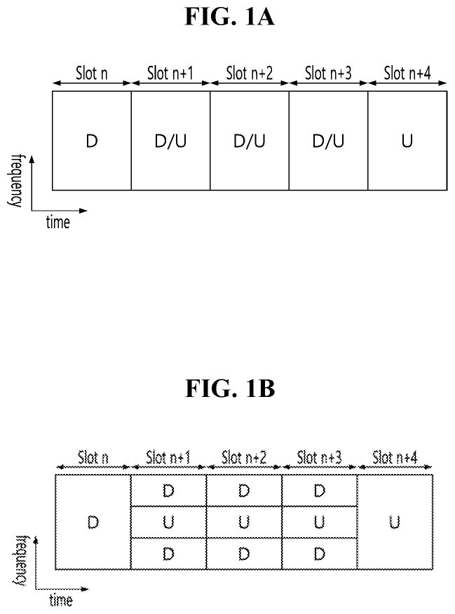

FIGS. 1A and 1B illustrate examples of allocation of uplink and downlink resources for same-band full duplex communication to which a method proposed in the present specification is applicable.

FIG. 1A illustrates an example of a resource structure for performing In-Band Full Duplex (IBFD) because Downlink(D)/Uplink (U) communications are simultaneously performed in some or all slots. FIG. 1B illustrates an example of a resource structure in which a band in each slot is divided into subbands and uplink and downlink resources are allocated to respective subbands, and shows a resource allocation structure for SBFD because full-duplex communication is performed under a structure in which each band is divided into subbands. In FIG. 1B, a guard band may be added to mitigate interference between subbands.

In FIGS. 1A and 1B, D denotes a slot for downlink, U denotes a slot for uplink, and D/U denotes a slot for simultaneously performing uplink and downlink resources.

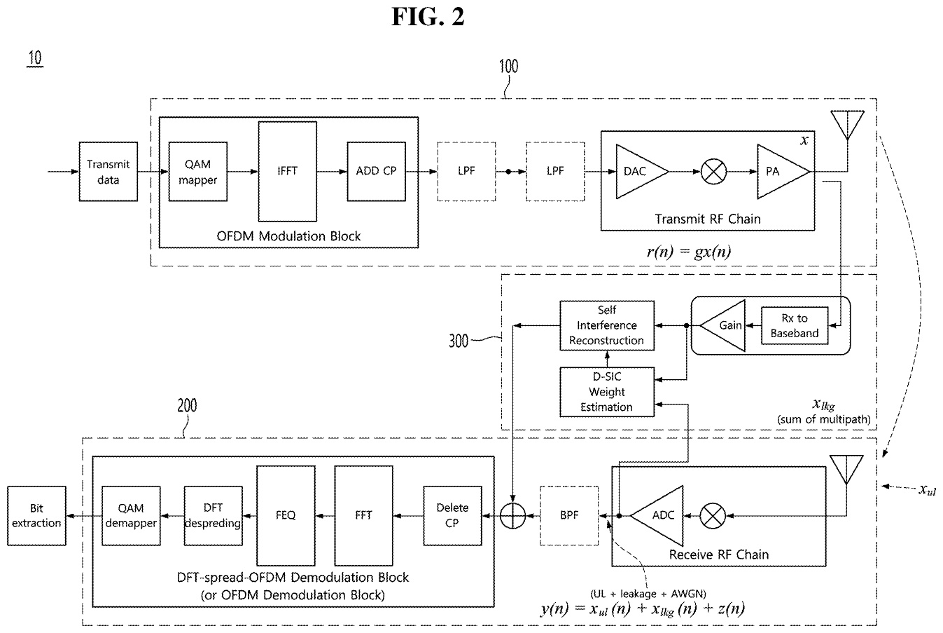

FIG. 2 illustrates an example of a conceptual internal block diagram of an overall physical layer system for same-band full duplex communication proposed in the present specification.

Although the internal block diagram of FIG. 2 is illustrated based on a base station 10, the internal block diagram of FIG. 2 may also be equally applied to a terminal. Here, the base station or the terminal may be represented by a wireless device 10, and the wireless device may refer to a device including a transmitter (or a transmission unit) and a receiver (or a reception unit). Referring to FIG. 2, transmit data (also referred to as transmission data) of a transmitter 100 undergoes an Orthogonal Frequency Division Multiplexing (OFDM)/Orthogonal Frequency Division Multiple Access (OFDMA) process in a baseband, is converted into an analog signal through a Digital-to-Analog Converter (DAC), is upconverted into a Radio Frequency (RF) signal, is amplified through a Power Amplifier (PA), and is then radiated through a transmit antenna. In this case, since excessive nonlinear distortion may occur in a transmission signal due to the power amplifier, functions such as Digital Pre-Distortion (DPD) and Crest Factor Reduction (CFR) may be additionally applied in the baseband or the like.

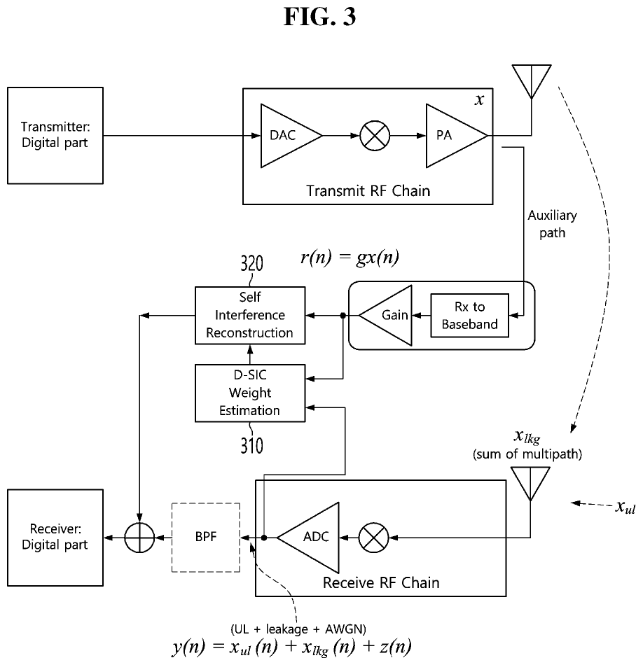

The signal radiated through the transmit antenna of the transmitter 100 is received through a receive antenna of an adjacent receiver 200. Such a signal acts as a significant obstacle to the receiver 200 in normally receiving, demodulating, and decoding uplink signals, and is referred to as a Self-Interference (SI) signal. SI contains not only a signal transferred from the transmit antenna of the transmitter 100 through the receive antenna of the receiver 200 but also a portion internally transferred along a circuit. The receiver 200 receives the foregoing SI signal and an uplink signal that is a target signal, together with noise. The signal received by the receiver 200 is downconverted to a baseband and is digitized through an Analog-to-Digital Converter (ADC). Thereafter, the receiver 200 recovers the signal by performing an OFDM/OFDMA decoding process on the digitized signal. In this case, when an uplink transmission signal is modulated and generated through Discrete Fourier Transform (DFT)-spread OFDM/OFDMA, the receiver 200 also performs demodulation based on the DFT-spread OFDM/OFDMA process. In this process, a procedure for cancelling SI is required to decode the uplink transmission signal without errors, and FIG. 3 illustrates a case in which a block for SI cancellation (or an SI cancellation module 300) is disposed between the transmitter 100 and the receiver 200 of the base station 10.

FIG. 3 illustrates an example of an internal block diagram for applying D-SIC proposed in the present specification, and presents only a core-related portion of FIG. 2 to describe an SI cancellation method in a digital domain. Referring to FIG. 3, it can be seen that an output signal of a power amplifier (PA) is denoted by x and is fed back to the digital domain of a receiver, together with a suitable gain, through an auxiliary path. The feedback digital domain signal r(n) is represented by r(n)=g·x(n). A signal y(n) received through the receive antenna of the receiver is downconverted to the baseband and digitized, and is then defined by the following Equation 1.

$$y ( n ) = {x}_{ul} ( n ) + {x}_{lkg} ( n ) + z ( n ) \qquad [ Equation 1 ]$$

In Equation 1, xᵤₗ(n) denotes a digital domain signal in which an uplink signal is received, z(n) denotes noise, and x_{lkg}(n) denotes a digital domain representation of the PA output x of the transmitter, which is transferred through a transmit-receive antenna path or the like. The reason for extracting a transmission signal, which will act as an interference signal at the receiver, from the PA output, without extracting it from the baseband of the transmitter is to basically perform an SI estimation process based on a linear scheme by excluding the PA or the like having strong nonlinear distortion characteristics from the path. x_{lkg}(n) is a digital domain signal of a signal obtained after x is received through multiple paths (i.e., multi-path structure). A D-SIC weight estimation block of FIG. 3 (or a D-SIC weight estimation unit 310) calculates a weight using a Wiener equation as shown in the following Equation 2.

$${\vec{w}}_{o} = {( {R}^{H} R )}^{- 1} {R}^{H} \vec{y} \qquad [ Equation 2 ]$$

In Equation 2, [symbol] is N×1 vector satisfying [symbol] =[w₀, w₁, . . . , w_{N-1}]^{t}, and is a vector for estimating a channel through which the SI signal is transferred via transmission/reception paths.

Further, R is a M×N matrix satisfying R=

$$[ \begin{matrix}r ( n ) & r ( n - 1 ) & … & r ( n - N + 1 ) \\ r ( n - 1 ) & r ( n ) & … & r ( n - N + 2 ) \\ ⋮ & ⋮ & ⋱ & ⋮ \\ r ( n - M + 1 ) & r ( n - M + 2 ) & … & r ( n )\end{matrix} ] ,$$

and [symbol] is an M×1 vector satisfying [symbol] =[y(n), y(n−1), . . . y(n−M+1)]^{t}. M corresponds to the length of an observation sequence for constructing the matrix and the vector. As M is a larger value, reliability further increases. Because r(n) is a signal transferred from the transmitter to the receiver within the same wireless device (e.g., base station or terminal), the matrices R and (R^{H}R)⁻¹R^{H} may be obtained in advance. In the present method, r(n) may be an arbitrary sequence, and does not need to be limited to a Zadoff-Chu sequence mainly used as a reference signal in 4G and 5G mobile communications. However, when channel estimation performance is considered, it is desirable that r(n) be a signal having white characteristics in a frequency domain. That is, it is advantageous in that symbols allocated for respective sub-carriers of OFDM use QPSK or Zadoff-Chu signals, rather than signals such as 16-QAM, as r(n).

$$s ( n ) = {\vec{w}}_{o}^{t} {\vec{r}}_{n} , {\vec{r}}_{n} = {[ r ( n ) r ( n - 1 ) … r ( n - N + 1 ) ]}^{t} \qquad [ Equation 3 ]$$

In Equation 3, s(n) is an estimated signal of SI reconstructed through a self-interference reconstruction block (or self-interference reconstruction unit 320). The estimated SI signal s(n) is removed from the reception signal y(n) of the digital domain, thus allowing the receiver to demodulate and decode the uplink signal without being greatly influenced by SI.

When a path which the self-interference (SI) signal undergoes is time-invariant, the SI signal may be reconstructed using the weight vector [symbol] determined based on the above-described scheme, and the effect of SI may be removed from the reception signal of the receiver. However, when the channel path varies over time (i.e., time-varying) due to complex reasons, the channel path needs to be adaptively estimated. The following Equation 4 represents an adaptive weight update scheme for the time-varying channel.

$${\vec{w}}_{n + 1} = {\vec{w}}_{n} + μ \cdot [ y ( n ) - s ( n ) ] [ \begin{matrix}r ( n ) \\ r ( n - 1 ) \\ ⋮ \\ r ( n - N + 1 )\end{matrix} ] \qquad [ Equation 4 ]$$

Equation 4 is identical to a Least Mean Square (LMS) algorithm widely known in the field of adaptive filters. In the method proposed in the present specification, Equation 4 is used as a scheme for adaptively updating and estimating a channel when the self-interference signal has time-varying characteristics. In Equation 4, μ is a constant for determining an adaptation speed, and is determined in consideration of a degree of temporal variation of the channel. Because updating each weight at each time-instant may cause an algorithm to operate with excessive sensitivity, Equation 4 may be modified into the following Equation 5 and applied to overcome this issue.

$${\vec{w}}_{n + 1} = {\vec{w}}_{n} + μ \cdot \sum [ y ( n ) - s ( n ) ] [ \begin{matrix}r ( n ) \\ r ( n - 1 ) \\ ⋮ \\ r ( n - N + 1 )\end{matrix} ] \qquad [ Equation 5 ]$$

Equation 5 is a scheme for updating the weight value by accumulating error vectors for a certain period of time. When the update period is set to a period of integer multiples of an OFDM symbol time, a phenomenon in which the value of the estimated channel changes within the length of one OFDM symbol may be prevented.

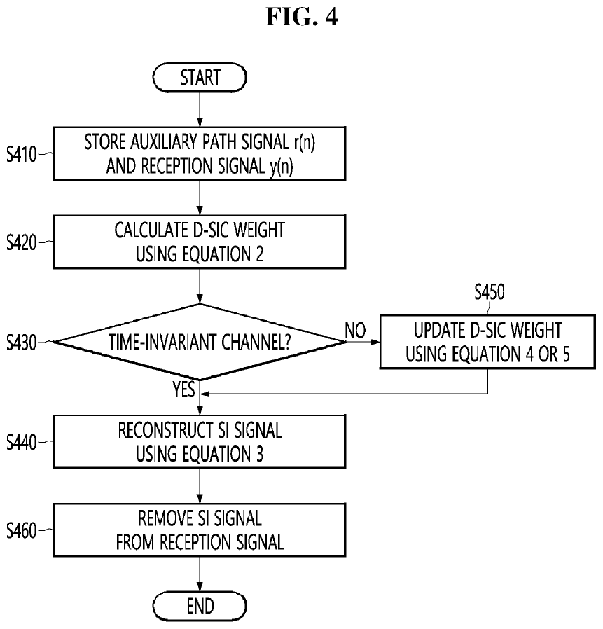

FIG. 4 is a flowchart illustrating an example of a D-SIC method proposed in the present specification.

Referring to FIG. 4, a wireless device (e.g., base station) stores an auxiliary path signal r(n) and a reception signal y(n), which are received by the receiver, in step S410, where 1≤n≤M.

Also, the receiver of the wireless device calculates a D-SIC weight [symbol] using Equation 2 in step S420.

Also, the wireless device determines whether a channel is a time-invariant channel in step S430.

When it is determined that the channel is the time-invariant channel, the wireless device reconstructs the SI signal using Equation 3 in step S440, whereas when it is determined that the channel is not a time-invariant channel, the wireless device updates a D-SIC weight using Equation 4 or 5 in step S450.

After step S440 or S450, the wireless device removes the estimated SI signal from the reception signal of the receiver (xᵤₗ(n)=y(n)−s(n)) in step S460.

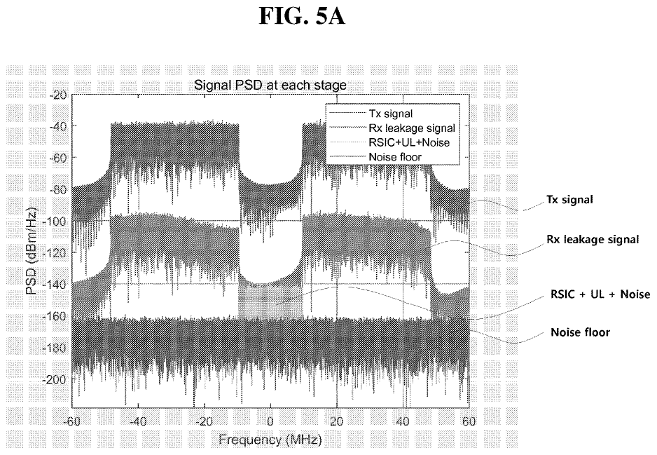

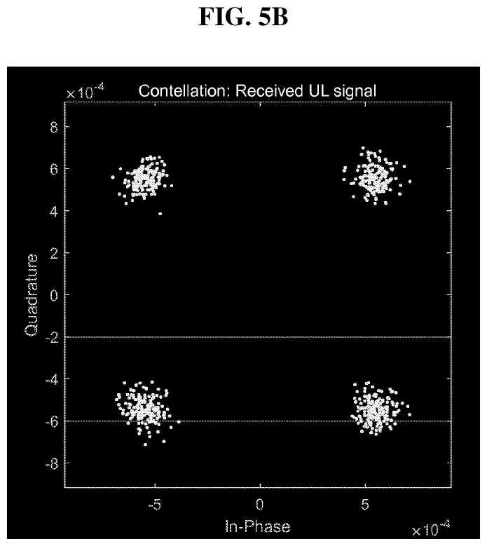

FIGS. 5A and 5B illustrate an example of the results of simulations conducted to verify the practical effectiveness of a method proposed in the present specification.

FIG. 5A illustrates the power spectral density (PSD) of a signal transmitted through a transmit antenna, a transmission leakage signal received after passing through multiple paths and antenna-level SIC, a combined signal of Residual Self-Interference (RSI) following D-SIC proposed in the present specification, an uplink signal, and noise, and the power density spectrum of the noise. The simulation of FIG. 5A shows simulation performed under the assumption of an SBFD scenario. It can be seen that the spectrum of an uplink signal is present only in an uplink subband after application of D-SIC and RSI decreases below a noise floor level for the remaining bands.

FIG. 5B illustrates the result of demodulation of an uplink signal after the D-SIC method proposed in the present specification is applied.

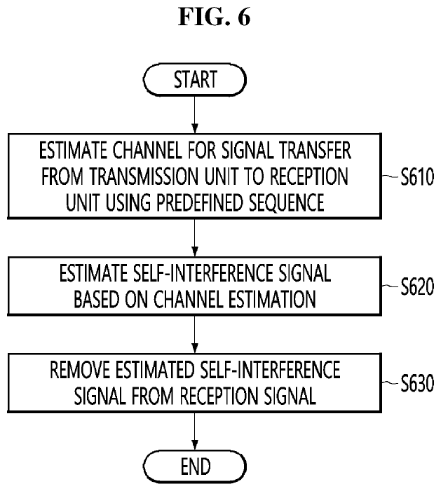

FIG. 6 is a flowchart illustrating an example of a method for a wireless device to cancel self-interference in a communication system supporting full-duplex communication proposed in the present specification.

First, the wireless device estimates a channel for signal transfer from the transmission unit (or transmitter) of the wireless device to the reception unit (or receiver) of the wireless device using a predefined sequence in step S610.

Also, the wireless device estimates a self-interference (SI) signal based on the channel estimation in step S620.

Further, the wireless device removes the estimated self-interference signal from a reception signal received by the reception unit in step S630.

The embodiments described above are combinations of components and features of the present disclosure in certain forms. Unless explicitly stated otherwise, each component or feature should be considered optional. Each component or feature may be implemented independently without being combined with other components or features. In addition, embodiments of the present disclosure may be configured by combining some components and/or features. The order of operations described in the embodiments of the present disclosure may be changed. Some components or features of one embodiment may be included in another embodiment, or may be substituted with corresponding components or features of another embodiment. It is apparent that claims that do not have an explicit dependency relationship in the claims may be combined to form an embodiment, or may be included as new claims through amendment after filing.

Embodiments according to the present disclosure may be implemented by various means, for example, hardware, firmware, software, or a combination thereof. In the case of implementation by hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

In the case of implementation by firmware or software, an embodiment of the present disclosure may be implemented in the form of modules, procedures, functions, or the like that perform the above-described functions or operations. Software code may be stored in a memory and executed by a processor. The memory may be located inside or outside the processor and may exchange data with the processor through various means that are already known.

It will be apparent to those skilled in the art that the present disclosure may be embodied in other specific forms without departing from the essential features of the present disclosure. Accordingly, the foregoing detailed description should be construed as illustrative rather than restrictive in all respects. The scope of the present disclosure should be determined by a reasonable interpretation of the accompanying claims, and all changes that come within the equivalent scope of the present disclosure are included within the scope of the present disclosure.

What is claimed is:

1. A wireless device for cancelling self-interference in a communication system supporting full-duplex communication, the wireless device comprising:
a transmission module configured to modulate transmission data in a baseband, upconvert a modulated signal to a radio frequency, and transmit a transmission signal through signal amplification;
a reception module configured to recover a signal by downconverting a reception signal to a baseband and demodulating the reception signal; and
a self-interference signal cancellation module configured to estimate a self-interference (SI) signal by estimating a channel for signal transfer from the transmission module to the reception module using a predefined sequence and to remove the estimated self-interference signal from the reception signal.

2. The wireless device as claimed in claim 1, wherein the self-interference signal cancellation module comprises:
a Digital Self-Interference Cancellation (D-SIC) weight estimation module configured to estimate the channel using the predefined sequence; and
a self-interference reconstruction module configured to estimate the self-interference signal through the channel estimated by the D-SIC weight estimation module.

3. The wireless device as claimed in claim 1, wherein the predefined sequence is composed of an output signal of a power amplifier of the transmission module and a preset gain.

4. The wireless device as claimed in claim 3, wherein the predefined sequence is fed back from the transmission module to the reception module through an auxiliary path of the wireless device.

5. The wireless device as claimed in claim 1, wherein the channel for signal transfer from the transmission module to the reception module is a time-invariant channel.

6. The wireless device as claimed in claim 5, wherein the time-invariant channel for signal transfer from the transmission module to the reception module is estimated using the following Equation:
$${\vec{w}}_{o} = {( {R}^{H} R )}^{- 1} {R}^{H} \vec{y}$$
where [symbol] is an N×1 vector satisfying [symbol] =[w₀, w₁, . . . , w_{N-1}]^{t}, R is an M×N vector satisfying
$$R = [ \begin{matrix}r ( n ) & r ( n - 1 ) & … & r ( n - N + 1 ) \\ r ( n - 1 ) & r ( n ) & … & r ( n - N + 2 ) \\ ⋮ & ⋮ & ⋱ & ⋮ \\ r ( n - M + 1 ) & r ( n - M + 2 ) & … & r ( n )\end{matrix} ] ,$$
r(n) is the predefined sequence, [symbol] is an M×1 vector satisfying [symbol] [y(n),y(n−1), . . . y(n−M+1)]^{t}, and M denotes a length of a sequence for constructing the matrix and the vectors.

7. The wireless device as claimed in claim 1, wherein the channel for signal transfer from the transmission module to the reception module is a time-varying channel.

8. The wireless device as claimed in claim 7, wherein the time-varying channel for signal transfer from the transmission module to the reception module is estimated using the following Equation:
$${\vec{w}}_{n + 1} = {\vec{w}}_{n} + μ \cdot [ y ( n ) - s ( n ) ] [ \begin{matrix}r ( n ) \\ r ( n - 1 ) \\ ⋮ \\ r ( n - N + 1 )\end{matrix} ]$$
where μ denotes a constant for determining an adaptation speed.

9. The wireless device as claimed in claim 7, wherein the time-varying channel for signal transfer from the transmission module to the reception module is estimated using the following Equation:
$${\vec{w}}_{n + 1} = {\vec{w}}_{n} + μ \cdot \sum [ y ( n ) - s ( n ) ] [ \begin{matrix}r ( n ) \\ r ( n - 1 ) \\ ⋮ \\ r ( n - N + 1 )\end{matrix} ]$$
where μ denotes a constant for determining an adaptation speed.

10. The wireless device as claimed in claim 1, wherein the estimated self-interference signal is defined by the following Equation:
$$s ( n ) = {\vec{w}}_{o}^{t} {\vec{r}}_{n} , {\vec{r}}_{n} = {[ r ( n ) r ( n - 1 ) … r ( n - N + 1 ) ]}^{t}$$
where s(n) denotes the estimated self-interference signal.

11. A method for a mobile device to cancel self-interference in a communication system supporting full-duplex communication, the method comprising:
estimating a channel for signal transfer from a transmission module of the wireless device to a reception module of the wireless device using a predefined sequence;
estimating a self-interference (SI) signal based on channel estimation; and
removing the estimated self-interference signal from a reception signal that is received by the reception module.

12. The method as claimed in claim 11, further comprising:
transmitting a transmission signal; and
recovering a reception signal from which the estimated self-interference signal is removed.

13. The method as claimed in claim 11, wherein the predefined sequence is composed of an output signal of a power amplifier of the transmission module and a preset gain.

14. The method as claimed in claim 13, wherein the predefined sequence is fed back from the transmission module to the reception module through an auxiliary path of the wireless device.

15. The method as claimed in claim 11, wherein the channel for signal transfer from the transmission module to the reception module is a time-invariant channel.

16. The method as claimed in claim 15, wherein the time-invariant channel for signal transfer from the transmission module to the reception module is estimated using the following Equation:
$${\vec{w}}_{o} = {( {R}^{H} R )}^{- 1} {R}^{H} \vec{y}$$
where [symbol] is an N×1 vector satisfying [symbol] =[w₀, w₁, . . . w_{N-1}]^{t}, R is an M×N vector satisfying
$$R = [ \begin{matrix}r ( n ) & r ( n - 1 ) & … & r ( n - N + 1 ) \\ r ( n - 1 ) & r ( n ) & … & r ( n - N + 2 ) \\ ⋮ & ⋮ & ⋱ & ⋮ \\ r ( n - M + 1 ) & r ( n - M + 2 ) & … & r ( n )\end{matrix} ] ,$$
r(n) is the predefined sequence, [symbol] is an M×1 vector satisfying [symbol] =[y(n),y(n−1), . . . y(n−M+1)]^{t}, and M denotes a length of a sequence for constructing the matrix and the vectors.

17. The method as claimed in claim 11, wherein the channel for signal transfer from the transmission module to the reception module is a time-varying channel.

18. The method as claimed in claim 17, wherein the time-varying channel for signal transfer from the transmission module to the reception module is estimated using the following Equation:
$${\vec{w}}_{n + 1} = {\vec{w}}_{n} + μ \cdot [ y ( n ) - s ( n ) ] [ \begin{matrix}r ( n ) \\ r ( n - 1 ) \\ ⋮ \\ r ( n - N + 1 )\end{matrix} ]$$
where μ denotes a constant for determining an adaptation speed.

19. The method as claimed in claim 17, wherein the time-varying channel for signal transfer from the transmission module to the reception module is estimated using the following Equation:
$${\vec{w}}_{n + 1} = {\vec{w}}_{n} + μ \cdot \sum [ y ( n ) - s ( n ) ] [ \begin{matrix}r ( n ) \\ r ( n - 1 ) \\ ⋮ \\ r ( n - N + 1 )\end{matrix} ]$$
where μ denotes a constant for determining an adaptation speed.

20. The method as claimed in claim 11, wherein the estimated self-interference signal is defined by the following Equation:
$$s ( n ) = {\vec{w}}_{o}^{t} {\vec{r}}_{n} , {\vec{r}}_{n} = {[ r ( n ) r ( n - 1 ) … r ( n - N + 1 ) ]}^{t}$$
where s(n) denotes the estimated self-interference signal.
